(19) United States
(12) Patent Application Publication
(10) Pub. No.: US 2014/0180814 A1
(43) Pub. Date: Jun. 26, 2014

(54) Method for a plurality of online digital video commercials on a consecutive and non consecutive viewing pattern applied for digital music file downloading over internet

(71) Applicant: Jean Pierre RAFENOMANJATO, Quebec QC (CA)

(72) Inventor: Jean Pierre RAFENOMANJATO, Quebec QC (CA)

(21) Appl. No.: 14/189,972

(22) Filed: Feb. 25, 2014

Related U.S. Application Data
(62) Division of application No. 13/077,643, filed on Mar. 31, 2011.

(51) Int. Cl. G06Q 30/02

(52) U.S. Cl. CPC G06Q 30/0255
USPC 705/14.53

(57) ABSTRACT

A method using TV advertising principles with some interactivity improvements, applied to the internet network domain is used to sponsor a free digital music file download by generating a sufficient amount of money which enables paying all royalties which are constituted by mechanical royalties, production royalties and recording artist royalties, giving the user a complete personal non-commercial license for the use of the digital music files he has just acquired; this process is made possible by using an algorithm to calculate the number of ads required, a process of selection of ads depending on different factors with different weighting but not limited to geographical location, event related, cyclic, targeted audience, special request; the audio file is available only after the viewing of all ads which is achieved by using a proprietary media player. This method is made possible through the support of a central internet server which includes a song database, advertising database, user database, data concerning standard copyright or specific contract-based copyright, a formula for the calculation of the number of adds required, automatic selection of advertising, and accounting process. This central database has the possibility of linking to external databases from outside partners to obtain songs or advertising, and to link to the computerized unit of the user through the internet network.

### CROSS-REFERENCE TO RELATED APPLICATIONS

Related Application No. 1: Fampat family
US2008270623 A1 20081030 [US20080270623]
STG: First published patent application
AP: 2006US-0089750 20061115
FD: PCT/U506/44400 20061115 [2006WO-US44400]
FD: Provisional: US 60739811-20051123 [2005US-P739811]

Related Application No. 2: Fampat family
US2007198660 A1 20070823 [US20070198660]
STG: First published patent application
AP: 2007US-0676662 20070220
FD: Provisional: US 60775214-20060221 [2006US-P775214]

Related application No. 3: Fampat family
KR20010046018 A 20010605 [KR20010046018]
STG: Unexamined patent application
AP: 1999KR-0049585 19991110

Related application No. 4: Fampat family
KR20010089031 A 20010929 [KR20010089031]
STG: Unexamined patent application
AP: 2000KR-0014127 20000320

Related application No. 5: Fampat family
KR20010076505 A 20010816 [KR20010076505]
STG: Unexamined patent application
AP: 2000KR-0003691 20000126

Related application No. 6: Fampat family
KR20010047990 A 20010615 [KR20010047990]
STG: Unexamined patent application
AP: 1999KR-0052446 19991124

Related application No. 7: Fampat Family
KR20010008019 A 20010205 [KR20010008019]
STG: Unexamined patent application
AP: 2000KR-0065087 20001102

Related application No. 8: Fampat Family
KR20000006853 A 20000207 [KR20000006853]
STG: Official gazette of the unexamined patents
AP: 1999KR-0049291 19991108

Related Application No. 9: Fampat family
FR2870952 A1 20051202 [FR2870952]
STG: Application, first publication
AP: 2004FR-0005637 20040525
WO2005119537 A1 20051215 [WO2005119537]
STG: Publ. Of in Appl. With int. Search rep
AP: 2005WO-FR50363 20050525
EP1754189 A1 20070221 [EP1754189]
STG: Public. Of applic. With search report
AP: 2005EP-0766690 20050525
CN1989522 A 20070627 [CN1989522]
STG: Unexamined application for a patent for inv.
AP: 2005CN-80025107 20050525
FR2870952 B1 20071019 [FR2870952]
STG: Patent of invention (2nd publication)
US2008209060 A1 20080828 [US20080209060]
STG: First published patent application
AP: 2007US-0597293 20071031
FD: PCT/FR2005/050363 20050525 [2005WO-FR05036]

Related application No. 10: Fampat family
JP2003076912 A 20030314 [JP2003076912]
STG: Doc. Laid open to publ. Inspec.
AP: 2001JP-0269490 20010905

### BACKGROUND

This invention relates to music file downloading over internet by means of standard computer or computerized units. More and more people have access to a computer, and internet access is spreading even more with faster and faster connection speeds, and an increasingly larger variety of devices of all sorts as well as mobile devices, are able to playback music. These three factors allow people to easily exchange and copy digital music files without any loss of quality. This situation causes a new problem, which is the illegal downloading (or sharing) of music files, meaning without compensating the copyright owners, artists and record companies, which is still a problem since several years, and despite thousands of lawsuits against companies and individuals, this problem still persists. Therefore, the industry has to find a practical and universal way of doing business to make music files available free of charge over the internet and compensate copyright owners.

### PRIOR ARTS

Both Application Nos. US2008270623 and KR20010046018 are offering music online services and inserting advertising among a music playlist comprising some differences between the two methods. This type of solution requires that when you want to listen to your music, you have to be connected to internet, the advertisement pattern is not well defined within those applications. It's not so critical essentially due to the fact that the amount required to be paid to digital rights owners is quite low, such as approximately $0.015, so any kind of advertisement rating at 15 CPM will be suitable for this purpose. With those types of methods, a person just listens to the music online, but never owns it.

Applications No.: KR20010089031, No.: KR20010076505, No.: KR20010047990, No.: KR20010008019, No.: KR20000006853, No.: US2007198660 are different processes for downloading music files, and they can be grouped together due to the fact that they are using related technologies based on inserting information which can be advertising within the music files. In this type of process, the user get a file which contains an advertisement, so each time the user wants to play the music, he has to see or listen to the ads before or during the playback of the song. In some the cases with a specific digital media player connected to a central database managed by internet, the need to play the ads ceases after a certain number of playbacks of those ads.

In the specific case of application No: FR2870952 (US2008209060): line 15 fr ( . . . an ad is posted . . . ) line 35, it is mentioned that one advertisement is played using a streaming process during the download process, the user has to watch this advertisement before being able to play the music file, which is encoded and saved on a proprietary format in the user computer, and requires a proprietary player including a specific plugging. The file contains an offline version, afterwards, when playing the file, if the user is not connected to internet, the offline version of the ad is played. In other cases of connections, the ad is streamed and played from the server. After viewing the ad a certain number of times, the user is allowed to save the file on a standard format such as MP3 or similar media. In this type of process, it's obvious that streaming one advertisement during the download process won't generate enough money to support all required amounts, such as royalties etc. . . . This way of doing things forces the process to send a polluted file which may include lighter ads within the musical file itself or a remote call for the original ads. Each time the user wants to play this file later on, he has to watch the ad before. The user won't be able to copy and play this file on a casual MP3 player or other devices and another computer where the proprietary plugging is not installed, not even being able to burn the file on a CD. This can be done only after a certain amount of time.

In Application No.: JP2003076912, the advertising is just mentioned as a process to be able to generate money to avoid illegal downloading. In order to reach a certain level of income that makes a project commercially viable, the advertising principle needs more research than just mentioning: “we display ads”. . . . A more realistic, practical and financially-sound way of doing business has to be found.

### SUMMARY

An improved way of reducing the illegal downloading of music and of satisfying the needs of ever increasing numbers of people to get music free of charge can be achieved by applying TV advertising principles to internet. Practically speaking we exchange their time spent on watching approximately three-minute of ads to be granted rights for personal use for one song, and it happens when the consumer is obtaining the song file by a specific downloading process. The advertising pattern could be 6 videos of thirty seconds or nine videos of twenty seconds, or any pattern that meets financial requirements. The time required to download an MP3 file is far less that the allocated advertising time slot so in order to oblige the user to watch all the ads, this is what the process is like: for explanation purposes let's say that for one song, the algorithm decides to display six different ads. Before the downloading process the first advertisement is initiated by a click to start song request; the media player makes a stop at the end of each advertisement and displays an arrow to click in order to start the next advertisement. At the end of the last advertisement, the user is invited to make a last click in order to obtain the certificate of personal use rights granted for the song and a standard MP3 or WAV file.

After this process is completed the user is granted a full personal use rights for the digital content for this song, he can copy and play it on all his standard audio devices, he can burn it on a CD or use it otherwise for personal purposes and uses.

### DRAWINGS

FIG. 1 is a perspective view of the first embodiment of the invention

FIG. 2 is a detail of the portion indicated as section A in FIG. 1

FIG. 3 is the detail of section 7 and 8 of FIG. 1

### REFERENCE NUMBERS

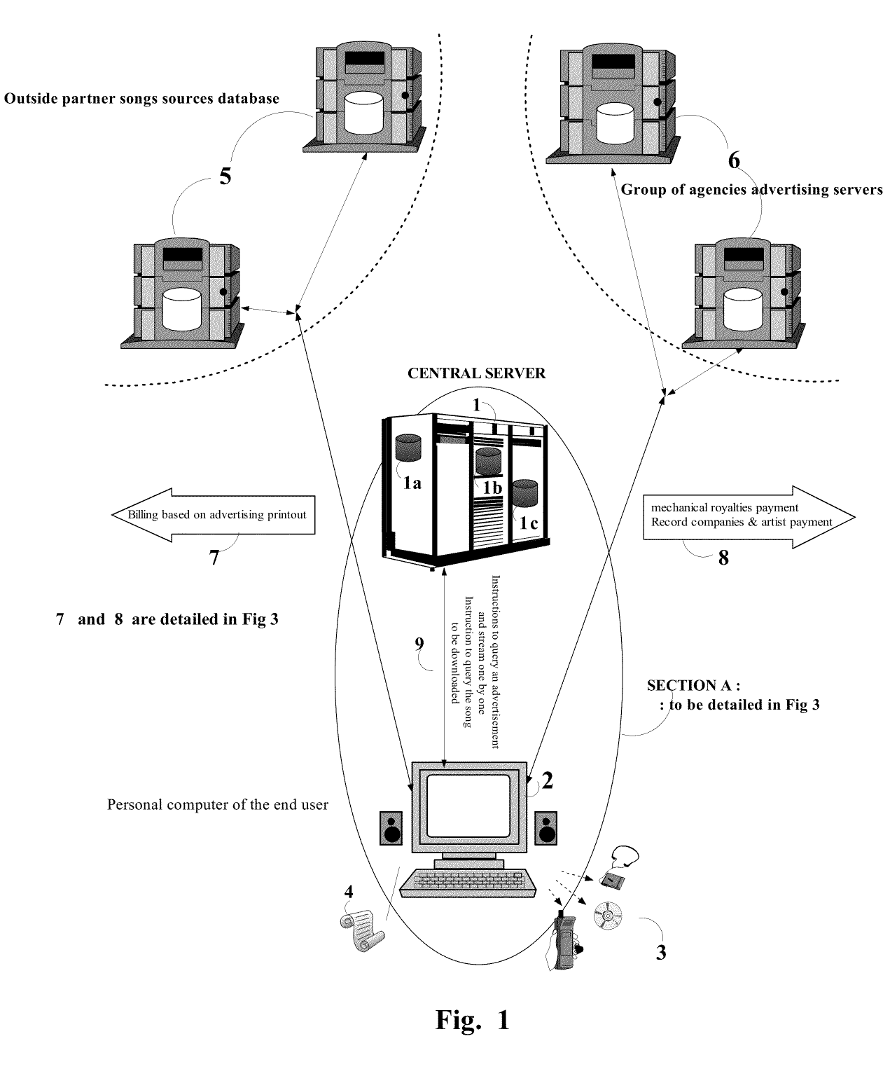

### FIG. 1

1 Main web server which is connected to the end users
a. 1a is the local advertising database included within the server 1
b. 1b is the operation management server and the users' and partners' database included within the server 1
c. 1c is a local song database included within the server 1

2 The end user computer

3 Peripheral digital media devices that belong to the end users.

4 The certificate of Rights granted to the end users for a song.

5 Outside partner song sources databases

6 Outside advertizing agency ad servers.

7 Process of generating money

8 Process of paying royalties owners.

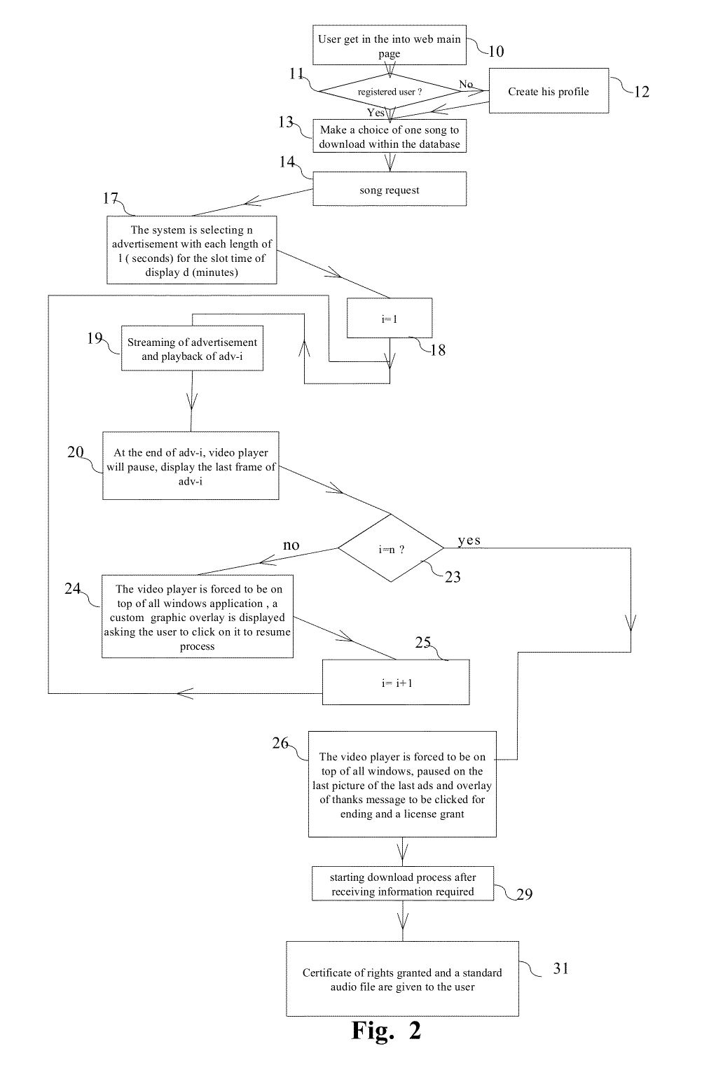

### FIG. 2

From 10 to 31 detailed process flow charts for online digital video streaming and file downloading

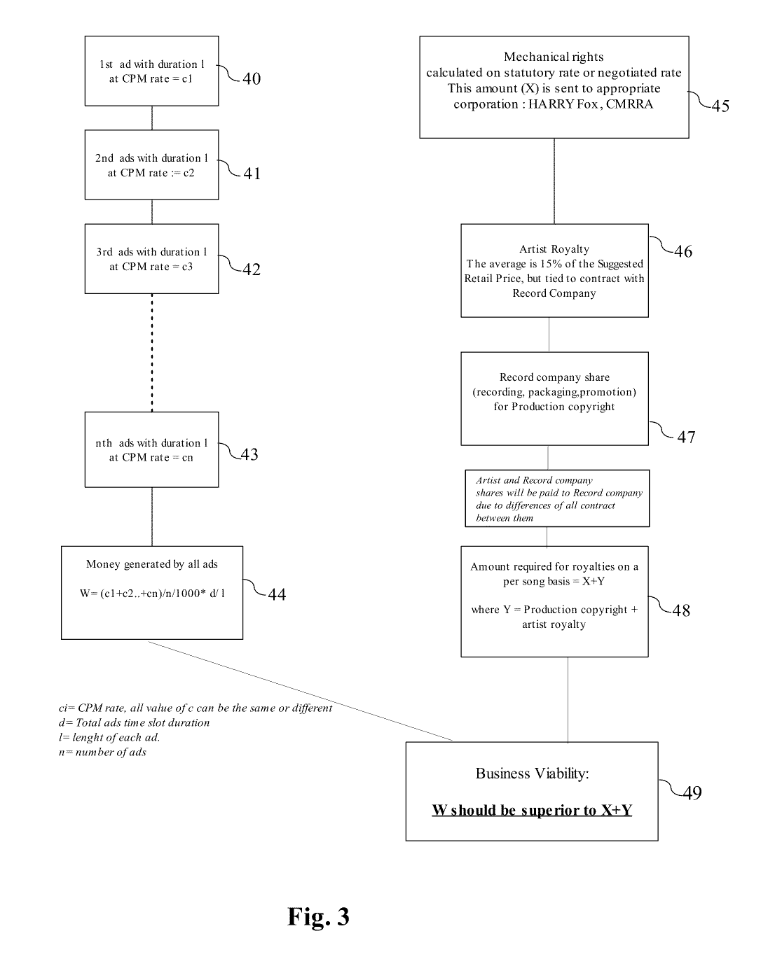

### FIG. 3

From 40 to 49: the base of the business advertising pattern required and the money owing.

### DETAILED DESCRIPTION OF FIRST EMBODIMENT

In order to make explanations easier to understand, the following description shall be limited to the core distinction of this invention. We will not explain the communications protocol within the computer server, using internet protocol which is of general knowledge

FIG. 1: is a perspective overall view of the first embodiment. It shows the central server 1 which is the central and operations management, the group of agencies ad servers 5 are existing ad servers which belong to advertising agencies and contain advertising from different announcers under contract. Those servers supply advertising on request through the central server 1. The outside partner songs sources databases are existing song databases from companies which may be recording companies or song wholesalers; they provide songs on request and data related to those songs. In some cases when wholesalers are under contract, they handle all copyright management themselves. The personal computer 2 is the personal computer of the end user, which can be any computerized device which able to access internet. From this computer, the user interacts with the central server 1 to request song files, using a process which will be detailed in FIG. 2. Media devices 3 are apparatus to which the end user may and is allowed to copy the song file for his personal use. After downloading, the user is granted a license 4 for this specific song, and a copy of this license is recorded within the central server to protect the user from any lawsuit concerning this song.

A local ad server 1a is located inside the central server which contains advertising from companies doing business directly without calling on an advertising agency and which mostly has the same function as the ad agency server. The local song database contains all songs which an independent artist or a recording company wants to make available without calling on wholesalers. This database contains all information related to the songs, in terms of CD, type, songwriters, publisher, recording company and UPC code. It contains also the information for all songs from the external song database. All this information, essentially concerning copyright ownership has to be validated before the song is available for downloading. The management database 1b contains a database of users, their profile and certificates for all songs that they have downloaded, and their account to which is added the value of CPM divided by 1000 of each advertisement after receiving the confirmation of viewing completion, and to which is subtracted the cost of the song(s) when the central server send to the personal computer downloading information required to download requested song(s). The result of those mathematical operation will be the account balance, this database include also information about artists, recording companies, publishers, songwriters and mechanical licensee organizations.

This database 1b contains information and algorithms to calculate mechanical and production copyright which include artist royalties. This can be based on standard calculations, in terms of specific contract and major country copyright calculations. It also contains all information related to advertising terms of contract and algorithms of automated advertisement selection based on the profile and geographical location of the user, standard or specific terms of contract and time frames.

This database will decide by using the financial requirement algorithm, how many advertising (n) has to be streamed, as well as deciding which advertising will be selected.

The following information gives details concerning prior information required before the process. each advertisement description contains its consumer targeted profile, for example people aged from 25 years old until 45 years old. each user profile contains his age, for example 30 years old. When the user profile is within the range of targeted profile, this advertisement is allowed to be viewed by the user.

When the downloading process is completed, it generates the certificate and keeps it on record.

FIG. 2 is a detailed perspective of the technical and the flow process of the invention. When the user makes his login and his profile is established, 10, 11, 12, he makes a search for a specific song 13 by title, by artist, or by using the album title. Even with a typographic error, the search engine will compensate any error and will return a list of songs with similar spelling. When the user makes a choice of song and requests a download 14, the database management FIG. 1, 1b, decides how many advertisement (n) has to be streamed to generate enough income to make the process profitable. It selects and makes a list of ‘n’ advertisements 17, and starts streaming the first advertisement and playing advertisement using a proprietary media player 19 which has no available controls except for minimizing the size of the window. During advertisement playback, the video portion of the advertisement will display on the full size of the browser screen and the user can't pause, stop, rewind, or fast forward the ads. At the end of the playback of the first advertisement 20, the video player is required to display full size and on top 20 and an overlaid arrow is displayed and the user is prompted to click. By clicking, it plays the next advertisement. This process will continue until the last advertisement. When this happens 26 the media player displays again on a full screen and on top status with an overlay arrow of the last frame of the last advertisement. The user will get a “thank you” message and be prompted to click on an overlaid arrow to get the certificate of rights granted for this song and a standard audio file in either WAV or MP3 format 29, and the certificate is displayed inviting the user to save it for proof of relative payment of duty for the download of this song 31.

FIG. 3 is the business model underlying the process and this part constitutes the business invention. This figure represents mostly sections 7 and 8 of FIG. 1. FIG. 3 has two main parts; the left one: 40 to 44 and the right one: 45 to 48.

The first part of the figure represents compulsory dues required in order to pay all copyrights related to the song. The amount of the copyright is divided in two parts. The first one 45 concerns mechanical rights, which is the right to reproduce the intellectual property. The mechanical rights, the amount of which we define as ‘X,’ belong to songwriters. The amount can be paid directly to the songwriters, or to their publishers or to the collection corporation mandated by publishers for collection purposes, such as Harry Fox in the USA, CMRRA in Canada and BIEM in Europe. The amount may vary slightly based on country copyright laws. The other royalties are for people and corporations who make the song in a form that is commercially usable. The production copyright belongs to a recording company 47, and the artist royalty is for the main recording artist. Those royalties are added together and we designate this amount as ‘Y’ due to the fact that in practice, recording artists are usually under contract with a recording company, so this amount will be paid to the recording company, which will have to pay the artist royalties according to their contract. 48

The second part: 40 to 44 represents the money inflow process, which has to generate enough money defined as ‘W’ to cover all the copyright that has to be paid. This condition has to be considered automatically by the database management 1b which decides on the number and selection of ads to be streamed. The incoming amounts are based on the following formula: W=((c1+c2 . . . +cn)/(n*1000))*(d/l) where “c1” is the CPM rater of the advertisement ranked as number 1 within the list of n advertisement, and “c2” the CPM rate of the advertisement ranked as number 2 within the list of n advertisement, continuing until the last advertisement of the list of n advertisement where “cn” is the CPM rate of the advertisement ranked number n within the list of n advertisement ‘d’ represents the total duration of all ads, ‘1’ represents the length of each ad, and ‘n’ the total number of consecutive ads. For example, 9 ads of CPM of 100 will generate $0.90 which is approximately the actual selling price for a song on internet for the time being.

For a easier reading, we will use the variable ‘i’ in relation with the list of ‘n’ advertisements, ‘i’ may take a value from 1 to ‘n’ and is used to identify advertisement ranking within the list.

We will identify the advertisement as follow:

‘adv-i’ requires a specific value of i for identification

for i=1, adv-i means the advertisement ranked as number 1 within the list

for i=2, adv-i means the advertisement ranked as number 2 within the list

for i=3, adv-i means the advertisement ranked as number 3 within the list continuing until

for i=n adv-i means the last advertisement ranked as number ‘n’ within the list

To get a viable practical and useful business model ‘W’ has to be greater than X+Y, (49)

### CONCLUSION

Therefore, the reader will note that at least one embodiment of this invention is a more practical and more financial business model. In fact, a majority of people are used to watching commercials during TV programming, and we apply this habit to the world of internet, which places the user in a familiar situation. The user can use his digital file immediately. It's a onetime transaction. In fact it may be considered that we pay the viewer $0.99 for 3 minutes of his time for viewing purposes, which is quite fair to be legal and to respect copyright owners.

Digital version of content that can be downloaded is divided in two groups, those without copyright and those copyrighted. In the case of the first group without copyright, any advertising configuration is suitable, because it's merely a profit for the organization, but for the copyrighted one, the main restraint is pay copyrights, which can be interpreted as each download process has to pay the copyrights for the content. In that case, advertising management has to be based on income generated and copyright to be paid as the formula described, using other parameters as file size, downloading time, of the contents won't be appropriate, because the copyright value is not related to those parameters, the value is related to the content by itself, for example, two songs with the same length meaning the same file size, may have different copyright value, which is decided by the copyright owners. Using a central server is appropriate due to the fact that each download may require different income.

While the description above contains many specific points, these should not be construed as limitations on its scope, but rather as an example of one embodiment.

Another embodiment may be the use of the same infrastructure as described in FIG. 1 but using a different process (steps), the end user is allowed to request and view advertisement(s) of his choice at any time of his choice, each confirmation of viewing completion will increase his account balance by the amount of the CPM of the advertisement, this step cam be done using any computerized device accessing internet. And when the user cumulates enough so its account balance is at least equal or superior to the cost of song(s), he is allowed to download this song(s)

Accordingly, the scope should be determined not by the embodiment illustrated but by the appended claims and their legal equivalents.

### GLOSSARY OF SOME TERMS SPECIFIC TO ADVERTISING BASED ON DIGITAL VIDEO AND MUSICAL INDUSTRY

“Printing or impression process”: means for that specific industry a process to play a video advertising on TV or computer display, so it can be watched by an audience, and the number of printing or impression is the mean for accounting report for billing
“Companion ads”: Commonly text, displays ads, rich media, which goal is to offer sustained visibility of the sponsor, it may offer click-through interactivity and rich media experiences.
Cost per mille (CPM), also called Cost per thousand (CPT) is a commonly used measurement in advertisement and online advertising. CPM reflects the cost per 1000 views of the ad.

Rights granted for personal use: means that the user is granted a non-exclusive, non-transferable rights to use, copy, store, transfer and burn the Digital Content for personal, non-commercial, entertainment use.

1. A distributing method for downloading song(s) to the personal computer of the end user connected to a network in a system in which a central server is the central and operations management and a series of outside partner songs sources database for downloading songs to the personal computer of the end user, and a group of agencies advertising servers for distributing advertising one by one on request to the personal computer of the end user, the method comprising the steps of:
(a) In the central server, retrieving and using from the management database 1b the end user profile in response to a request from the personal computer of the end user, querying and listing from the management database 1b all advertisements which are allowed to be distributed to the end user.
(b) In the central server sending to the personal computer of the end user the list of all advertisements which are allowed to be distributed to the end user.
(c) In the central server sending to the personal computer of the end user the calling address of the particular advertising server hosting the particular advertisement and its identification in response to the personal computer of the end user request of viewing content of an advertisement of his choice from the list of all advertisement received from the central server.
(d) In the personal computer of the end user, after completion of the advertisement, through an overlaid arrow, sending to the central server, information for the confirming completion of this advertisement.
(e) In the central computer, awaiting confirmation of completion signal from the personal computer of the end user, if no signal is received after a standard web page time out (which is a standard well known process with a most common duration of 30 minutes) the central computer ends the session with the personal computer of the end user.
(f) In the central computer in response to receipt of confirmation of completion of advertisement viewing through an overlaid arrow, the central server increase the account balance in the end user profile contained within the management database 1b by the amount of the CPM of the advertisement divided by 1000 and returning to step (c)
(g) In the central server sending to the personal computer of the end user, downloading information required to download requested song(s), including the calling address of the particular outside partner songs sources databases and its (their) identification(s). conditional to the value of the account balance in the end user profile contained within the management database 1b is superior or at least equal to the associate costs of the songs requested described as X+Y contained within the management database 1b, in response of a request of song(s) download from personal computer of the end user.
(h) In the personal computer of the end user by receiving downloading information required, starts download from the outside partner songs sources databases, using standard and generally well known internet downloading process.
